(19) United States
(12) Patent Application Publication
(10) Pub. No.: US 2006/0101178 A1
(43) Pub. Date: May 11, 2006

(54) Arbitration in a multi-protocol environment

(76) Inventors: Tina C. Zhong, Chandler, AZ (US); James Mitchell, Chandler, AZ (US)

Correspondence Address: FISH & RICHARDSON, PC, P.O. BOX 1022, MINNEAPOLIS, MN, 55440-1022, US

(21) Appl. No.: 10/984,693

(22) Filed: Nov. 8, 2004

(51) Int. Cl. G06F 13/00

(52) U.S. Cl. 710/112

(57) ABSTRACT

Packets are selected from a plurality of requesting agents for processing. The processing includes arbitrating enqueuing of the packets to a plurality of queues. A queue of the plurality of queues is repeatedly selected from which a packet is dequeued.

### BACKGROUND

This invention relates to arbitration in a multi-protocol environment.

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Special Interest Group (PCI-SIG) manages PCI specifications (e.g., PCI Express Base Specification 1.0a, published Apr. 15, 2003) as open industry standards, and provides the specifications to its members.

Advanced Switching (AS) is a technology which is based on the PCI Express architecture, and which enables standardization of various backplane architectures. AS utilizes a packet-based transaction layer protocol that operates over the PCI Express physical and data link layers. The AS Specification provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The Advanced Switching Interconnect Special Interest Group (ASI-SIG) is a collaborative trade organization chartered with providing a switching fabric interconnect standard, specifications of which it provides to its members.

In an environment in which traffic from various sources and/or traffic of various types share communications resources, some type of arbitration scheme is typically used to ensure each source and/or type of traffic is serviced appropriately.

### BRIEF DESCRIPTION OF THE DRAWINGS

FIG. 1 is a block diagram of a switch fabric.

FIG. 2 is a diagram of protocol stacks.

FIG. 3 is a diagram of an AS transaction layer packet (TLP) format.

FIG. 4 is a diagram of an AS route header format.

FIG. 5 is a block diagram of an end point.

FIG. 6 is a block diagram of a VC arbitration module.

FIG. 7 is a block diagram of a VC queue arbiter.

FIG. 8 is a diagram of states of an arbitration FSM.

FIGS. 9A-9B are block diagrams of configurable queue data structures.

### DETAILED DESCRIPTION

FIG. 1 shows a switch fabric 100. The switch fabric 100 includes switch elements 102 and end points 104. End points 104 can include any of a variety of types of hardware, e.g., CPU chipsets, network processors, digital signal processors, media access and/or host adaptors). The switch elements 102 constitute internal nodes of the switch fabric 100 and provide interconnects with other switch elements 102 and end points 104. The end points 104 reside on the edge of the switch fabric 100 and represent data ingress and egress points for the switch fabric 100. The end points 104 are able to encapsulate and/or translate packets entering and exiting the switch fabric 100 and may be viewed as “bridges” between the switch fabric 100 and other interfaces (not shown) including other switch fabrics.

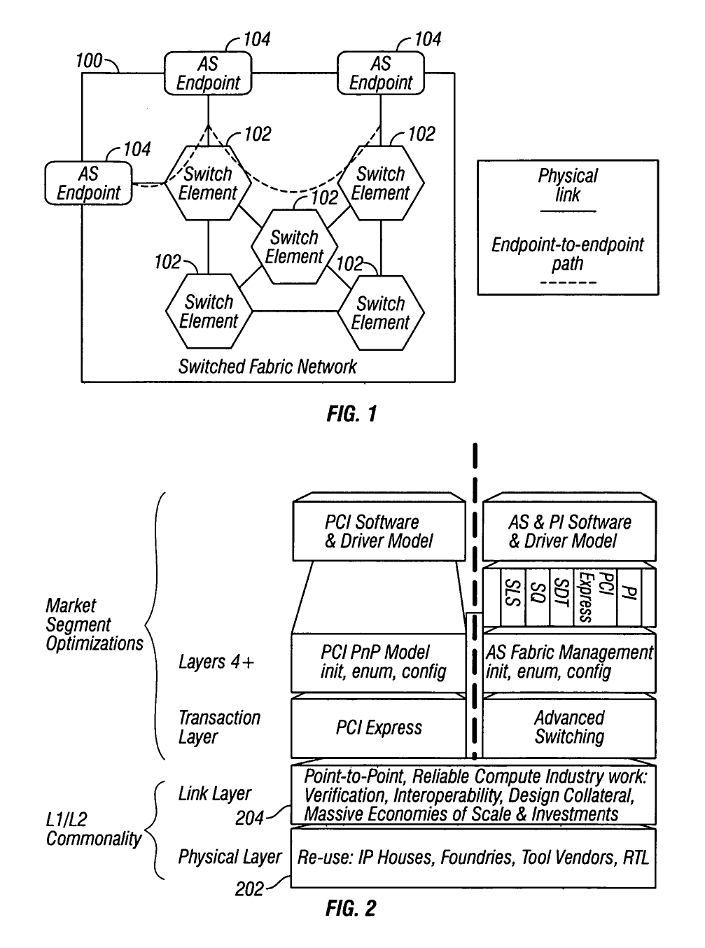

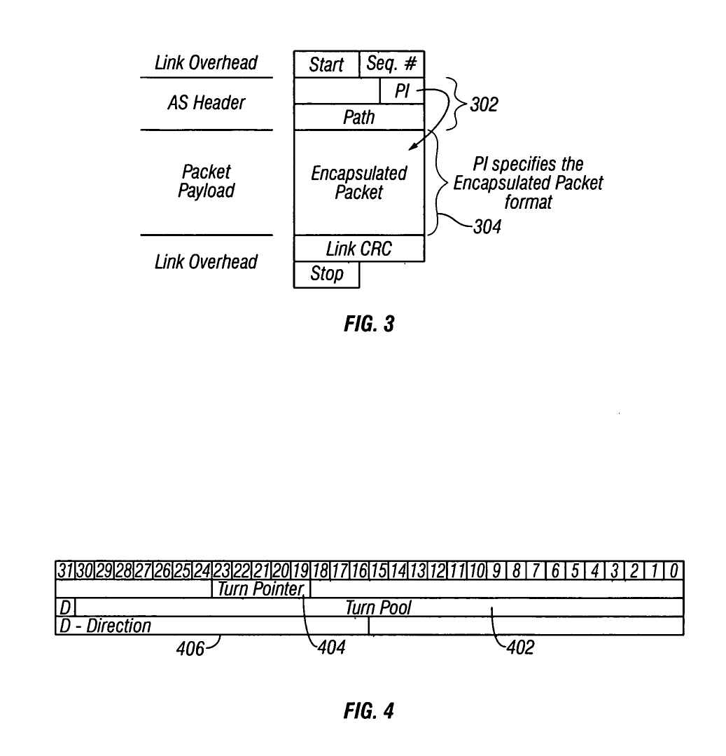

Each switch element 102 and end point 104 has an Advanced Switching (AS) interface that is part of the AS architecture defined by the “Advance Switching Core Architecture Specification” (e.g., Revision 1.0, December 2003, available from the Advanced Switching Interconnect-SIG at ), hereafter referred to as “AS Specification.” The AS Specification utilizes a packet-based transaction layer protocol that operates over the PCI Express physical and data link layers 202, 204, as shown in FIG. 2. AS uses a path-defined routing methodology in which the source of a packet provides all information required by a switch (or switches) to route the packet to the desired destination. FIG. 3 shows an AS transaction layer packet (TLP) format 300. The TLP format 300 includes an AS header field 302 and a payload field 304. The AS header field 302 includes a Path field 302A (for “AS route header” data) that is used to route the packet through an AS fabric, and a Protocol Interface (PI) field 302B (for “PI header” data) that specifies the Protocol Interface of an encapsulated packet in the payload field 304. AS switches route packets using the information contained in the AS header 302 without necessarily requiring interpretation of the contents of the encapsulated packet in the payload field 304.

A path may be defined by the turn pool 402, turn pointer 404, and direction flag 406 in the AS header 302, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field 302B in the AS header 302 determines the format of the encapsulated packet in the payload field 304. The PI field 302B is inserted by the end point 104 that originates the AS packet and is used by the end point that terminates the packet to correctly interpret the packet contents. The separation of routing information from the remainder of the packet enables an AS fabric to tunnel packets of any protocol.

The PI field 302B includes a PI number that represents one of a variety of possible fabric management and/or application-level interfaces to the switch fabric 100. Table 1 provides a list of PI numbers currently supported by the AS Specification.

TABLE 1
AS protocol encapsulation interfaces

| PI number | Protocol Encapsulation Identity (PEI) |
|---|---|
| 0 | Fabric Discovery |
| 1 | Multicasting |
| 2 | Congestion Management |
| 3 | Segmentation and Reassembly |
| 4 | Node Configuration Management |
| 5 | Fabric Event Notification |
| 6 | Reserved |
| 7 | Reserved |
| 8 | PCI-Express |
| 9-95 | ASI-SIG defined PEIs |
| 96-126 | Vendor-defined PEIs |
| 127 | Reserved |

PI numbers 0-7 are used for various fabric management tasks, and PI numbers 8-126 are application-level interfaces. As shown in Table 1, PI number 8 (or equivalently ”PI-8”) is used to tunnel or encapsulate a native PCI Express packet. Other PI numbers may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS Specification supports the establishment of direct endpoint-to-endpoint logical paths through the switch fabric 100 using, at each hop along the path, one of multiple independent logical links known as Virtual Channels (VCs) that share a common physical link on that hop. This enables a single switch fabric to service multiple, independent logical interconnects simultaneously, each VC interconnecting AS nodes (e.g., end points or switch elements) for control, management and data. Each VC provides its own queue so that blocking in one VC does not cause blocking in another. Each VC may have independent packet ordering requirements, and therefore each VC can be scheduled without dependencies on the other VCs.

The AS Specification defines three VC types: Bypass Capable Unicast (BVC); Ordered-Only Unicast (OVC); and Multicast (MVC). BVCs have bypass capability, which may be necessary for deadlock free tunneling of some, typically load/store, protocols. OVCs are single queue unicast VCs, which are suitable for message oriented “push” traffic. MVCs are single queue VCs for multicast “push” traffic.

The AS Specification provides a number of congestion management techniques, one of which is a credit-based flow control technique that ensures that packets are not lost due to congestion. Link partners (e.g., an end point 104 and a switch element 102, or two switch elements 102) in the network exchange flow control credit information to guarantee that the receiving end of a link has the capacity to accept packets. Flow control credits are computed on a VC-basis by the receiving end of the link and communicated to the transmitting end of the link. Typically, packets are transmitted only when there are enough credits available for a particular VC to carry the packet. Upon sending a packet, the transmitting end of the link debits its available credit account by an amount of flow control credits that reflects the packet size. As the receiving end of the link processes the received packet (e.g., forwards the packet to an end point 104), space is made available on the corresponding VC. Flow control credits are then returned to the transmission end of the link. The transmission end of the link then adds the flow control credits to its credit account.

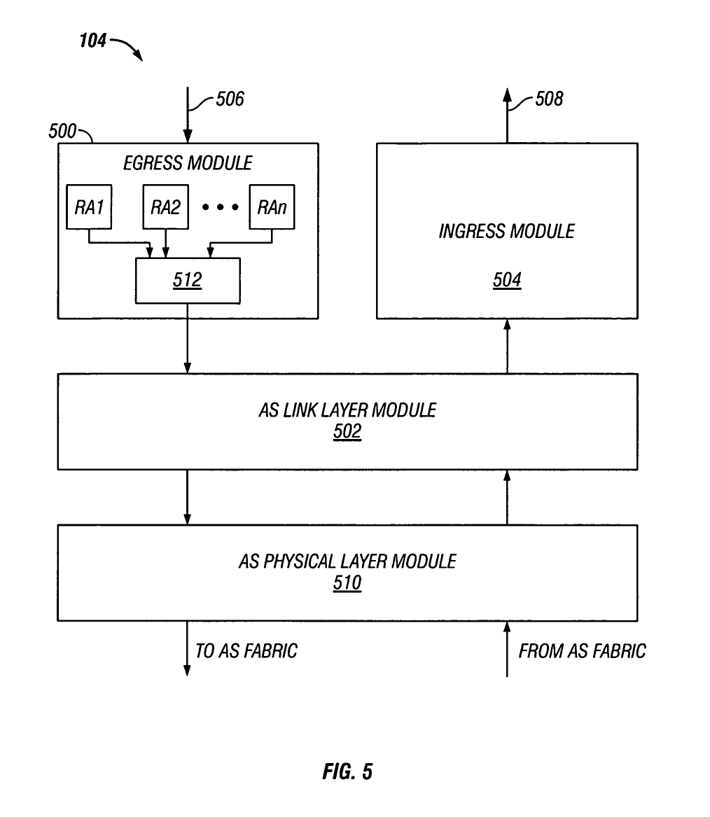

FIG. 5 shows a block diagram of functional modules in an implementation of an end point 104. The end point 104 includes an egress module 500 for transmitting data into the switch fabric 100 via an AS link layer module 502. The end point also includes an ingress module 504 for receiving data from the switch fabric 100 via the AS link layer module 502. The egress module 500 implements various AS transaction layer functions including building AS transaction layer packets, some of which include encapsulated packets received over an egress interface 506. The ingress module 504 also implements various AS transaction layer functions including extracting encapsulated packets that have traversed the switch fabric 100 to send over an ingress interface 508. The AS link layer module 502 is in communication with an AS physical layer module 510 that handles transmission and reception of data to and from a neighboring switch element 102 (not shown).

The egress module 500 includes a VC arbitration module 512 that handles requests from multiple (n) PI requesting agents (RA1, RA2, . . . , RAn) to send packets into the switch fabric 100. In an implementation of the end point 104, each requesting agent handles packets corresponding to a particular PI or group of PIs. For example, one PI requesting agent may be dedicated to building PI-8 packets and submitting them to the VC arbitration module 512 to be sent through the switch fabric 100.

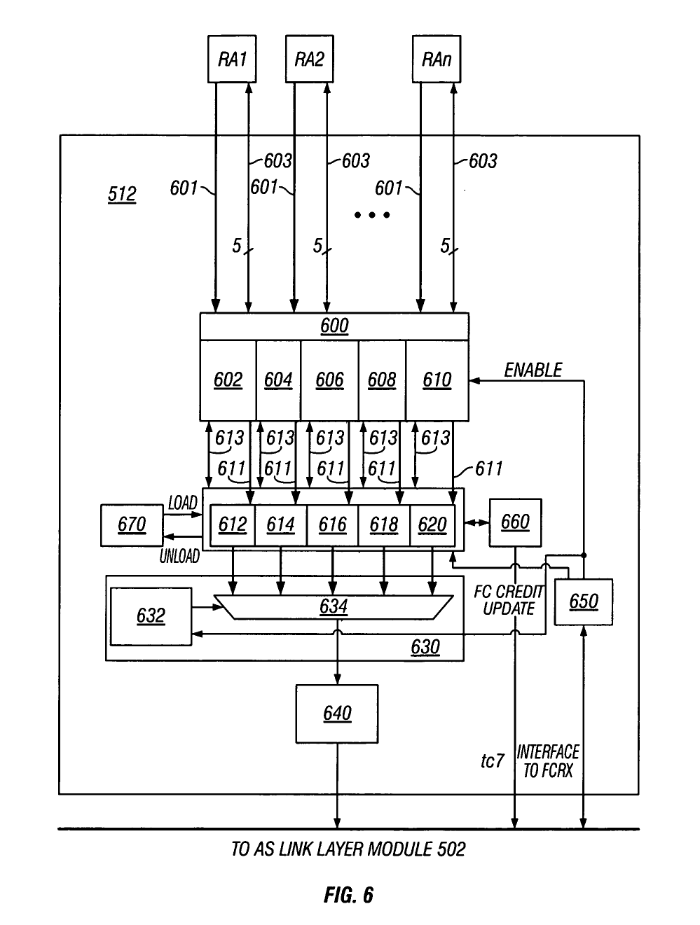

FIG. 6 shows a block diagram of an implementation of the VC arbitration module 512. The VC arbitration module 512 performs two stages of arbitration: a first stage that enqueues packets into one of a set of (m) VC queues 612, 614, 616, 608 and 620, and a second stage that dequeues packets from the VC queues for passing to the AS link layer module 502. Each VC queue corresponds to a Virtual Channel that is available at the end-point 104. In this case, there are five (m =5) VC queues, other implementations may include more or fewer Virtual Channels and corresponding VC queues and VC queue arbiters.

The first stage of arbitration includes distribution of packets based on VC type. Each packet to be serviced is associated with a particular VC type which is known to the PI requesting agent (e.g., based on information in the packet such as PI number and/or Traffic Class (TC)). Each of the VC queues can be configured to store packets of a particular VC type, as described in more detail below. In general, a VC queue of a particular VC type receives packets typically from multiple of the PI requesting agents which are submitting packets of that VC type. The PI requesting agent determines a VC queue to which it submits each packet, for example, based on the VC type of that packet.

Each VC queue has a dedicated VC queue arbiter. This dedicated VC queue arbiter selects packets to enqueue from all of the PI requesting agents whose packets are distributed to it. A packet distributor 600 distributes packets from the n PI requesting agents, passing each packet to one of the m VC queue arbiters 602, 604, 606, 608 and 610 based on control signals from the PI requesting agents that indicate through which VC (and corresponding VC queue) the packet should be processed (e.g., based on VC type). Each of the n PI requesting agents has dedicated data and control lines to the packet distributor 600 represented by data lines 601 and control lines 603.

Each VC queue arbiter arbitrates among the packets submitted by multiple PI requesting agents applying a policy to determine which packet to service next. In some implementations, each VC queue arbiter services packets from multiple PI requesting agents in a round robin fashion and enqueues these packets onto the VC queue associated with that VC queue arbiter.

In the second stage of arbitration, a fabric arbiter 630 arbitrates among packets stored in the set of m VC queues 612, 614, 616, 608 and 620. The fabric arbiter 630 includes a control unit 632 that selects a VC queue using a multiplexer (MUX) 634. The fabric arbiter 630 dequeues the packets and sends the packets to a Cyclic Redundancy Check (CRC) generator 640 that appends a CRC to the packet before sending it to the AS link layer module 502 for transmission over the switch fabric 100.

In some implementations, each of the VC queue arbiters is configured to handle packets corresponding to one of the VC types: BVC, OVC and MVC. In the example shown in FIG. 6, VC queue arbiter 602 is a “BVC-type” arbiter. VC queue arbiters 604, 606 and 608 are “BVC/OVC-type” arbiters that are capable of converting to either a “BVC-type” or an “OVC-type” during a setup phase. VC queue arbiter 608 is an “MVC-type” arbiter. Conversion of“BVC/OVC-type” arbiters can occur according to the AS Core Specification. There are also different types of VC queues that store packets of one of the VC types. Communications between a VC queue arbiter and the corresponding VC queue use a data buses 611 and control lines 613.

Each VC is associated with a particular VC arbiter and VC queue. A configurable queue data structure is configured to match the type of the VC queue to the type of the corresponding VC queue arbiter. The configurable queue data structure uses one internal queue for an OVC or an MVC and two internal queues for a BVC, as described in more detail below.

A flow control transmit module 650 initializes the VC queue arbiters and provides for conversion between BVC and OVC types after a system reset. The flow control transmit module 650 provides received flow control credit updates from a link partner to regulate the appropriate VC queue. The flow control transmit module 650 also generates flow control packets that contain receive queue credit information for the link partner.

The VC queues are implemented across a “clock boundary” between a “host domain” that uses a first clock timing and a “link” domain that uses a second clock timing. The write pointers of the VC queues transition according to the timing of the host domain, while the read pointers of the VC queues transition according to the timing of the link domain. A clock synchronizer 670 is used to convert signals (e.g., “load” and “unload” signals) such that the signals transition according to the appropriate clock timing.

When there are enough flow control credits for a packet at the head of a VC queue to be transmitted, the packet will be in a “ready mode.” If the head of the queue has been lacking credits for a long time then a packet starvation timer 660 times out and generates a timeout message to notify the appropriate PI requesting agent. A packet in the “ready mode” can be transmitted at the appropriate time according to the arbitration scheme used by the fabric arbiter 630.

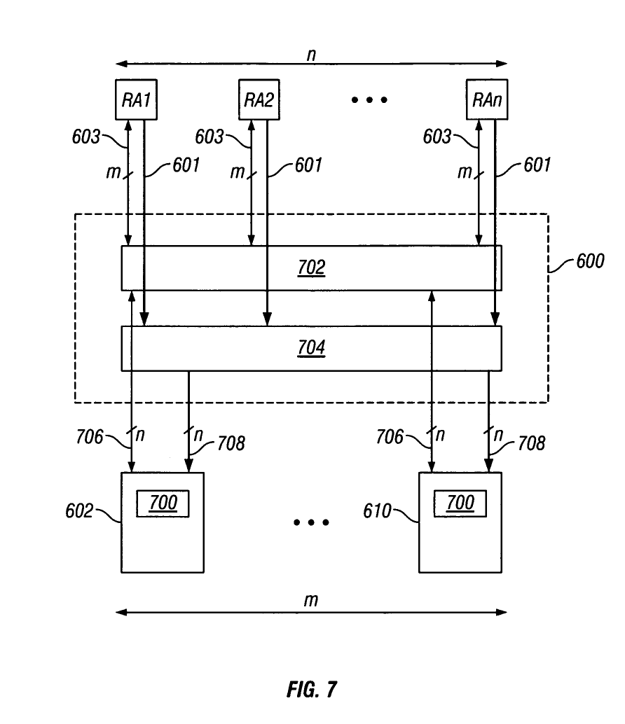

In the first stage of arbitration, each of the multiple VC queue arbiters 602, 604, 606, 608 and 610 (see FIG. 6) independently provide any number of PI requesting agents access to a VC queue that stores packets for transmission into the switch fabric 100. FIG. 7 illustrates an interface provided by the packet distributor 600 for communication between the n PI requesting agents RA1-RAn and the m VC queue arbiters 602, 604, 606, 608 and 610. The packet distributor 600 includes a fully connected control distribution network 702 to distribute control signals, and a data bus distribution network 704 to distribute packet data. The control distribution network 702 distributes to each VC queue arbiter n sets of control lines 706, including a set of control lines from each of the n PI requesting agents. The data bus distribution network 704 includes n data buses 708, each receiving data from a different one of the n PI requesting agents. Each VC queue can receive data from any of the n data buses.

In some implementations, each VC queue arbiter includes an arbitration finite state machine (FSM) 700 that uses the control signals to accept packets one at a time from a data bus of one of the PI requesting agents and transfers the packets to a VC queue. In some implementations, the interface with all PI requesting agents is uniform, enabling the arbitration FSM 700 to implement an arbitration scheme that can be easily expanded to incorporate additional vendor specific PI numbers or future ASI-SIG defined PI numbers. The arbitration FSM 700 can also handle exceptions like bypassing a state and returning to a previously bypassed state. Some PI requesting agents handle packets for more than one PI number.

One implementation of a bus protocol used by an VC queue arbiter and a PI requesting agent to communicate over the packet distributor 600 between corresponds to a hand-shake protocol. When a PI requesting agent has a packet available, that PI requesting agent asserts an initiator ready signal (“irdy”) corresponding to an appropriate one of the VC queue arbiters. For example, the control signals 603 include five pairs of irdy signals, irdyA-irdyE, used by a PI requesting agent to select one of the five VC queue arbiters 602, 604, 606, 608 and 610, respectively. The PI requesting agent places data onto a data bus 601 and asserts the irdy signal corresponding to the selected VC queue arbiter. The PI requesting agent may select a particular VC queue arbiter, for example, because VC queue arbiter 606 is set up to provide a BVC-type VC and the PI requesting agent needs to send a bypassable packet.

There may be multiple PI requesting agents providing data to and asserting control signals to select a particular VC queue arbiter. It is the job of the selected VC queue arbiter to perform an arbitration protocol to select, in turn, a particular PI requesting agent by asserting an appropriate target ready (“trdy”) signal. The control signals 603 include five pairs of trdy signals, trdyA-trdyE. After the selected VC queue arbiter asserts the corresponding “trdy” back, the PI requesting agent starts transferring the packet data. The PI requesting agent puts new data onto the data bus on every clock cycle. The information collected by the VC queue arbiter includes, for example, “dword enable” (indicating which data words in a a parallel bus contain valid data), “start of packet indication,” “end of packet indication,” and the packet data.

When multiple PI requesting agents are vying for the VC queue at the same time, a round robin arbitration scheme is used. The VC queue arbiter 606 follows the round robin order and moves to the next available state of the arbitration FSM 700 based on the assertion of initiator ready signals. If no packets are available, the arbitration FSM 700 parks in its current state in anticipation of the next packet. In addition to the above rules, the arbitration FSM 700 has the following features:

If a VC queue for ordered packets becomes full and the next request is from an ordered packet, the arbitration FSM 700 finishes its current state transfer and moves into that corresponding state and waits until the VC queue becomes available.

If a VC queue for bypassable packets becomes full, the arbitration FSM 700 moves to the next non-bypassable requester, e.g., an ordered queue requester. The skipped state will be remembered. Once the bypassable queue becomes available again, the arbitration FSM 700 finishes its current transfer then moves back to the previously skipped state. If multiple bypassable requests are being skipped, only the first one is recorded. The rest are serviced in the round robin fashion. For this purpose, all bypassable states are placed together next to the ordered state group.

If there is a back-to-back request from a particular PI requesting agent, the second request will only be accepted when there are no requests from other PI requesting agents.

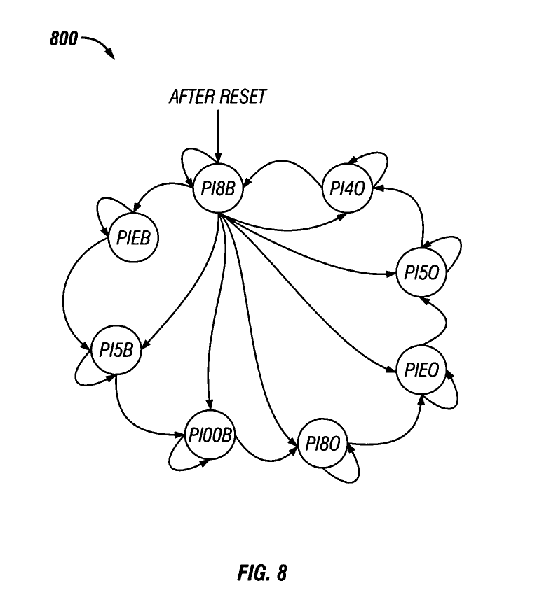

FIG. 8 shows one example of a state transition diagram 800 showing the states and some transition arcs of the arbitration FSM 700. For clarity of the drawing, not all transition arcs are shown in the diagram 800 of FIG. 8. Eight states correspond to an implementation of a VC queue arbiter for arbitrating among eight PI requesting agents labeled: PI8B, PI4O, PI50, PIEO, PI8O, PI00B, PI5B and PIEB (the suffix “B” refers a “bypassable state” and the suffix “O” refers to an “ordered state”). PI8B is arbitrarily chosen to illustrate the complete set of transition arcs. The rest of the states include a similar set of transition arcs.

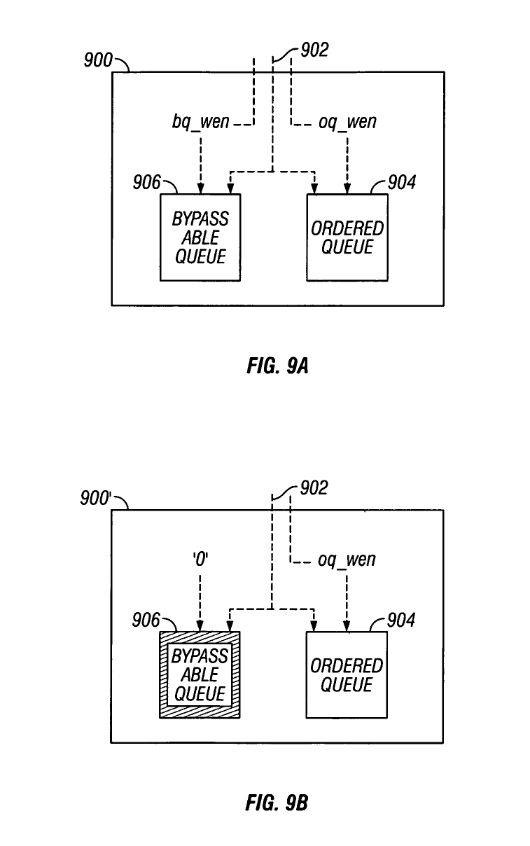

FIG. 9A shows a block diagram of an exemplary configurable queue data structure 900 used to implement a VC queue. The arbitration module 512 can configure the configurable queue data structure 900 to implement any of the three VC types. The configurable queue data structure 900 includes two internal queues 904 and 906 for implementing the BVC-type VC queue. The OVC-type and MVC-type VC queues use only one of the internal queues.

When configured as a BVC-type VC queue, the data structure 900 uses the first internal queue 904 for ordered packets (asserting the “oq_wen” signal to enable writing of data on bus 902 to queue 904) and the second internal queue 906 for bypassable packets (asserting the “bq_wen” signal to enable writing of data on bus 902 to queue 906). When configured as an OVC-type VC queue or an MVC-type VC queue 900′ (FIG. 9B), the data structure 900′ uses the first internal queue 904 for ordered packets, but does not use the second internal queue 906. When a VC queue arbiter corresponds to a BVC/OVC-type arbiter, the configurable queue data structure 900 is configured to match the VC type of the arbiter after conversion to either a BVC-type or an OVC-type, e.g., as determined by the capabilities of a link partner.

In the second stage of arbitration, the fabric arbiter 630 selects packets to dequeue from the VC queues in a way that ensures a balanced management of the switch fabric 100 and reduces latency in the packet transmission paths. The fabric arbiter 630 arbitrates among different VC queues according to the priorities associated with the corresponding VCs. For example, the fabric arbiter 630 uses a 32-phase weighted round-robin selecting a packet from a queue during each phase and allocating a number of consecutive phases to a particular VC queue based on the priorities. The fabric arbiter 630 selects a packet after it is in the “ready mode” and is at the head of a VC queue. The fabric arbiter 630 sends a selected packet to the CRC generator 640. The CRC generator 640 generates a Header CRC and appends the generated Header CRC to the AS header field of the TLP. Depending on the characteristics of a packet, the CRC generator 640 also generates a Packet CRC and appends the generated Packet CRC to the TLP. The complete TLP is then sent to the AS link layer module 502.

The fabric arbiter 630 is also able to perform certain duties of a “fabric manager” which regulates traffic in order to allow Traffic Class 7 (TC7) packets to be transmitted with highest priority. Since TC7 packets can pass through any type VC (e.g., BVC, OVC, MVC), the fabric arbiter 630 also handles a second level of arbitration between multiple TC7 packets. All these decisions can be made within one clock cycle so that the latency in the transmit path is kept at a minimum.

In some implementations the fabric arbiter 630 selects a BVC-type VC queue as a dedicated VC queue for bypassing TC7 packets. If there is only one BVC-type VC queue, then that VC queue is used both for TC7 packets and other bypassable traffic. In one arbitration scheme the fabric arbiter 630 uses the following rules:

As long as the dedicated TC7 VC queue is not empty, the fabric arbiter 630 will exhaust all packets from that VC queue first. The dedicated TC7 VC queue refers to a queue that only holds TC7 packets. If there are multiple dedicated TC7 queues from different VCs, a round robin arbitration scheme is used to select the next packet to transmit.

The fabric arbiter 630 serves the other VC queues once all packets in the dedicated TC7 VC queue(s) are cleared. The fabric arbiter 630 reads entries from an arbitration table to make a decision about the next VC queue from which to select a packet. The arbitration table lists which VC queues are serviced in which of the 32 phases. Table pointers are incremented once a queue is serviced. When the end of the table has been reached, the fabric arbiter 630 resets its table pointer to the beginning.

The techniques described in this specification can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Processes described herein can be performed by one or more programmable processors executing a computer program to perform functions described herein by operating on input data and generating output. Processes can also be performed by, and techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of these techniques, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method comprising:
selecting packets from a plurality of requesting agents for processing, including arbitrating enqueuing of the packets to a plurality of queues; and
repeatedly selecting a queue of the plurality of queues from which to dequeue a packet.

2. The method of claim 1, wherein the arbitrating includes:
arbitrating among a first subset of the plurality of requesting agents to enqueue a packet from a first selected requesting agent to a first queue of the plurality of queues;and
arbitrating among a second subset of the plurality of requesting agents to enqueue a packet from a second selected requesting agent to a second queue of the plurality of queues.

3. The method of claim 2, wherein the first subset overlaps with the second subset.

4. The method of claim 3, wherein the first subset is identical to the second subset.

5. The method of claim 1, wherein at least some of the requesting agents provide packets corresponding to one or more Advanced Switching Protocol Interface types.

6. The method of claim 1, wherein the arbitrating comprises performing round-robin arbitration.

7. The method of claim 1, wherein at least one of the plurality of queues comprises a memory structure that preserves an order of stored packets according to an order the stored packets were received.

8. The method of claim 1, wherein at least one of the plurality of queues comprises a memory structure that enables stored packets to be ordered in a different order from an order the packets were received.

9. The method of claim 8, further comprising determining whether to store a packet from one of the requesting agents in the different order from an order the packet was received based on information in the packet.

10. The method of claim 9, further comprising storing the packet in a first portion of the memory structure if the information in the packet indicates storing the packet according to received order, and storing the packet in a second portion of the memory structure if the information in the packet indicates storing the packet out of received order.

11. The method of claim 1, wherein repeatedly selecting a queue of the plurality of queues comprises performing weighted round-robin arbitration to repeatedly select a queue.

12. The method of claim 11, further comprising selecting a queue of the plurality of queues according to the weighted round-robin arbitration only if a predetermined high priority one of the plurality of queues is empty, and selecting the high priority queue if the high priority queue is not empty.

13. The method of claim 1, further comprising processing the dequeued packet.

14. The method of claim 13, wherein processing the dequeued packet comprises adding a cyclic redundancy check to the dequeued packet.

15. The method of claim 13, further comprising sending the processed packet through a switch fabric.

16. Software stored on a computer-readable medium comprising instructions for causing a computer system to:
select packets from a plurality of requesting agents for processing, including arbitrating enqueuing of the packets to a plurality of queues; and
repeatedly select a queue of the plurality of queues from which to dequeue a packet.

17. The software of claim 16, wherein at least some of the requesting agents provide packets corresponding to one or more Advanced Switching Protocol Interface types.

18. An apparatus comprising:
a plurality of arbiters, each configured to select packets from a plurality of requesting agents for processing, including arbitrating enqueuing of the packets to one of a plurality of queues corresponding to that arbiter; and
a multiplexer coupled to the plurality of queues for repeatedly selecting a queue of the plurality of queues from which to dequeue a packet.

19. The apparatus of claim 18, wherein:
a first of the plurality of arbiters is configured to arbitrate among a first subset of the plurality of requesting agents to enqueue a packet from a first selected requesting agent to a first queue of the plurality of queues; and
a second of the plurality of arbiters is configured to arbitrate among a second subset of the plurality of requesting agents to enqueue a packet from a second selected requesting agent to a second queue of the plurality of queues.

20. The apparatus of claim 19, wherein the first subset overlaps with the second subset.

21. The apparatus of claim 20, wherein the first subset is identical to the second subset.

22. The apparatus of claim 18, wherein at least some of the requesting agents provide packets corresponding to one or more Advanced Switching Protocol Interface types.

23. A system comprising:
a switch fabric; and
a device coupled to the network including:
a plurality of arbiters, each configured to select packets from a plurality of requesting agents for processing, including arbitrating enqueuing of the packets to one of a plurality of queues corresponding to that arbiter; and
a multiplexer coupled to the plurality of queues for repeatedly selecting a queue of the plurality of queues from which to dequeue a packet.

24. The system of claim 23, wherein at least some of the requesting agents provide packets corresponding to one or more Advanced Switching Protocol Interface types.
